(19) United States
(12) Patent Application Publication
(10) Pub. No.: US 2024/0013276 A1
(43) Pub. Date: Jan. 11, 2024

(54) CONNECTED VEHICLE DATA USAGE FRAMEWORK

(71) Applicant: FORD GLOBAL TECHNOLOGIES, LLC, Dearborn, MI (US)

(72) Inventors: Venkata Maruthe Ravikumara Sharma CHENGALVALA, Troy, MI (US); James Wilhelm HEATON, Saline, MI (US)

(21) Appl. No.: 17/859,812

(22) Filed: Jul. 7, 2022

(51) Int. Cl. G06Q 30/06; G06Q 30/02

(52) U.S. Cl. CPC G06Q 30/0631; G06Q 30/0613; G06Q 30/0281

(57) ABSTRACT

Performing vehicle analytics using connected data captured from potential vehicle customers is provided. Connected data indicative of usage by a customer of one or more vehicles is received in real-time. The connected data is analyzed to determine a per-customer recommendation based on the usage. The per-customer recommendation is sent to a dealership in real-time to advise the dealership.

### TECHNICAL FIELD

Aspects of the disclosure relate to performing vehicle analytics using connected data captured from vehicle customers.

### BACKGROUND

Some vehicle manufacturers are moving from a vehicle centric model to a customer centric model. A typical customer may spend several hours at a dealership to close a sale. This delay may be caused by the customer and the dealership working to identify which model of vehicle and/or which vehicle features are desired by the customer.

### SUMMARY

In one or more illustrative examples, a system for performing vehicle analytics using connected data captured from potential vehicle customers is provided. A server includes a hardware processor configured to execute a usage analysis service to receive connected data indicative of usage by a customer of one or more vehicles in real-time, analyze the connected data to determine a per-customer recommendation based on the usage, and send the per-customer recommendation to a dealership in real-time to provide the dealership with individualized incentives or recommendations for enticing the customer to purchase one of the one or more vehicles.

In one or more illustrative examples, a method for performing vehicle analytics using connected data captured from potential vehicle customers is provided. Connected data indicative of usage by a customer of one or more vehicles is received in real-time. The connected data is analyzed to determine a per-customer recommendation based on the usage. The per-customer recommendation is sent to a dealership in real-time to provide the dealership with individualized incentives or recommendations for enticing the customer to purchase one of the one or more vehicles.

In one or more illustrative examples, a non-transitory computer-readable medium includes instructions for performing vehicle analytics using connected data captured from potential vehicle customers, that, when executed by a server, cause the server to perform operations including to receive connected data indicative of usage by a customer of one or more vehicles in real-time; analyze the connected data to determine a per-customer recommendation based on the usage; and send the per-customer recommendation to a dealership in real-time to provide the dealership with individualized incentives or recommendations for enticing the customer to purchase one of the one or more vehicles.

### BRIEF DESCRIPTION OF THE DRAWINGS

FIG. 1 illustrates an example system for performing vehicle analytics using connected data captured from potential vehicle customers;

FIG. 2 illustrates an example of operation of a machine learning component to determine patterns in the connected data;

FIG. 3 illustrates an example data flow for operation of the system to analyze the connected data;

FIG. 4 illustrates an example process for the collection of connected data to be provided to the usage analysis service for analysis;

FIG. 5 illustrates an example process for the analysis of connected data by the usage analysis service of the analysis server to provide per-customer recommendations;

FIG. 6 illustrates an example process for using abstracted data from a plurality of instances of connected data to offer recommendations across multiple customers; and

FIG. 7 illustrates an example computing device for performing vehicle analytics using connected data captured from potential vehicle customers.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Each customer may form certain habits through his lifetime. Some of these habits may be inherited, and some may be learned. The creation of habits may include the factors of reminder, routine, and reward. (See Duhigg, Charles “The Power of Habit.” Random House Books, 2013 for further information on the creation of habits and the 3Rs.) These habits may have an influence on vehicle 102 purchases. Data captured by the dealerships and during test drives can be used to identify the correct vehicle 102, features, and incentives based on the customer's habits. Associating these factors of habit formation with the experience data and driving behavior data at the dealership can help original equipment manufacturers (OEMs) offer instant incentives, recommend correct vehicle and features, resulting in customer delight.

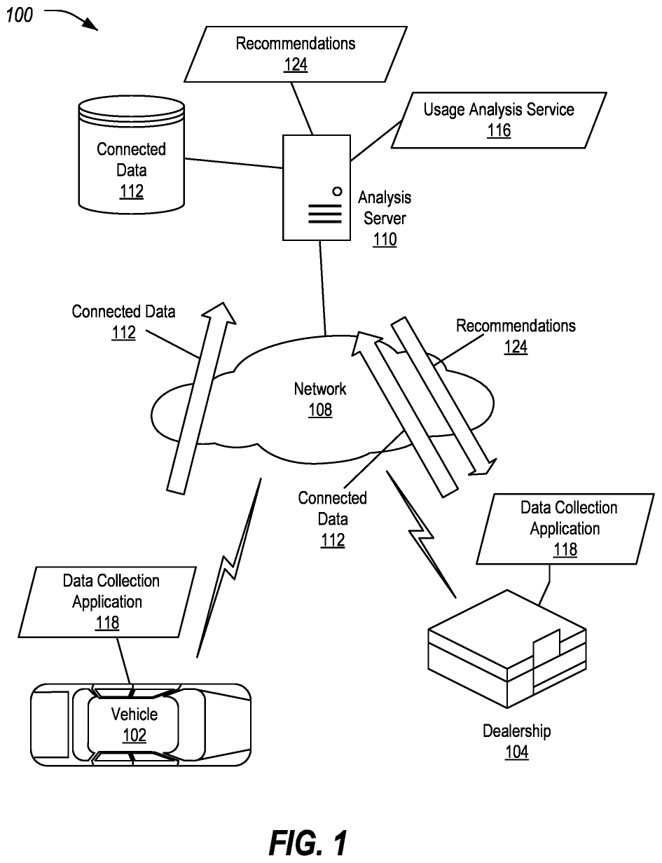

FIG. 1 illustrates an example system 100 for the performance of vehicle 102 analytics using connected data 112 captured from potential vehicle 102 customers. Vehicles 102 and dealerships 104 of the system 100 may be configured to communicate over a communications network 108. An analysis server 110 may be configured to receive connected data 112 from the vehicles 102 and/or from the dealerships 104. Using the connected data 112, the analysis server 110 may be configured to generate recommendations 124. The recommendations 124 may include suggestions on vehicles 102 to recommend to a customer for purchase and/or incentives to improve vehicle 102 sales across customers or within a geographic area.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), globally unique identifiers (GUIDs), customer or fleet accounts, etc.

The dealership 104 may include one or more facilities for the purchase and sale of vehicles 102. In some cases, the dealership 104 operates at a retail level based on a dealership 104 contract with an automaker. The dealership 104 may employs salespeople to aid in the sales of the vehicles 102. A typical customer may spend several hours at a dealership 104 to close a sale. This may be cause, in part, by the customer and the dealership 104 working to identify which model of vehicle 102 and/or which vehicle 102 features are desired by the customer.

The dealerships 104 may further include various computing services to support the communication of the dealerships 104 personnel with infrastructure and/or with the vehicles 102 themselves. In an example, the dealerships 104 may include wireless transceivers, such as a BLUETOOTH or BLUETOOTH Low Energy (BLE) transceivers, as well as transceivers for communication over the communications network 108. The communications network 108 may include one or more interconnected communication networks such as the Internet, a cable television distribution network, a satellite link network, a local area network, and a telephone network, as some non-limiting examples. The vehicle 102 may also include a telematics control unit (TCU). The TCU may include network hardware configured to facilitate communication between the vehicle 102 and other devices of the system 100. For example, the TCU may include or otherwise access a cellular modem configured to facilitate communication with the communications network 108.

The analysis server 110 may be an example of a networked computing device that is accessible to the vehicles 102, dealerships 104, and/or mobile devices 106 over the communications network 108. The analysis server 110 may be configured to receive various data from the elements of the system 100. In an example, the analysis server 110 may be configured to receive connected data 112 from the vehicles 102. For instance, the vehicle 102 may execute a data collection application 118 to provide connected data 112 to the analysis server 110 with respect to use of the vehicle 102. In another example, the analysis server 110 may be configured to receive connected data 112 from one or more computing devices of the dealerships 104 executing the data collection application 118.

The connected data 112 may include, for example, dealership 104 locations and/or addresses, VINs or other identifiers of the vehicles 102 available at the dealership 104, locations of the vehicles 102, ignition status of the vehicles 102, which features of the vehicles 102 were accessed during which time periods, customer use of the human machine interface (HMI) of the vehicle 102, ignition on/off times and locations, driving behavior of the vehicle 102, start points, paths, and/or end points for test drive routes that are traversed by the vehicles 102, distance traveled, time spent in the vehicles 102 by customers, customer decisions whether or not to purchase the vehicles 102, etc.

As some further examples, the connected data 112 may include routes taken during test drives (e.g., local vs highway vs country route, etc.). These routes may be logged to be used to determine customer's interest and offer appropriate packages and accessories. User interface analytics may also be logged to list of all the features accessed and tested by the customer at the dealership 104 and during the test drive. Time spent on testing various features at the dealership 104 and during the test drive may also be logged. In another example, the customer's color choices and HMI preferences can be captured. The connected data 112 from multiple customers may also be aggregated and used to determine a general broader customer choice. Driving behavior patterns during the test drives may also be captured and appropriate premium features may be suggested (e.g., lane keeping assist, reverse parking assist, etc.) Discounts may be tailored for individual customers, as well as scheduled maintenance packages tailored to the customer.

A usage analysis service 116 may be an example of an application executed by the analysis server 110. As explained in further detail herein, the usage analysis service 116 may be configured to receive the connected data 112. The connected data 112 may be used to determine the recommendations 124 for vehicles 102 and/or incentives on the vehicles 102. In one example, the usage analysis service 116 may receive the connected data 112 from the dealership 104 and/or the vehicles 102 while the customer is searching for a vehicle 102, to allow the recommendations 124 to be providing back to the dealership 104 in real-time during the customer's time looking for the vehicle 102 to purchase. In another example, the usage analysis service 116 may determine recommendations 124 across many customers, which may be useful for incentives programs or to increase vehicle 102 turn rates at the dealerships 104.

The operation of the system 100 may be illustrated by way of various use cases. In a first use case, braking at a traffic light may be illustrative. Referring back to the factors for forming habits, the reminder for this behavior, the cue or trigger that initiates the habit, may be the changing of the color of the traffic signal to red. The routine of the habit, the action customer takes, may be to press the brakes. The reward, or the benefit customer gains from the action, is the proper slowing of the vehicle 102. Influencers for this use case may be varied, and may include factors such as the customer's mood, the time of the day, the traffic volume. These factors may influence whether the slowing is a smooth action, a harsh action, etc. Harsh braking may a measurable parameter identified in the connected data 112. This connected data 112 during the test drive that indicated harsh braking may cause the analysis server 110 to recommend a package including premium brakes.

In a second use case, a customer's entertainment choices during a drive may be illustrative. The reminder for this behavior may be one or more of time of the day, whether family members are accompanying the user, music preferences or a combination thereof. These factors may be measurable due to customer interaction with the vehicle 102. The routine of this habit may include the action of the customer selecting and/or turning on entertainment functions. The benefit the customer gains from the action may include one or more of enjoying the music, relaxing, engaging with the customer's kids, etc. The music channel and/or application the customer uses at the dealership 104 and/or during test drive may help to determine what entertainment package can be offered to customers to encourage the customers to buy the package along with vehicle 102.

In a third use case, a customer's entertainment choices while the vehicle 102 is in parked condition may be illustrative. The reminder for this behavior may be one or more of time of the day, mode of the vehicle 102 (e.g., park, neutral, drive, etc.), location (e.g., at school parking lot waiting to pick up kids). The routine of this habit may include the action of the customer selecting and/or turning on entertainment functions, such as gaming, watching streaming media, etc. The benefit the customer gains from the action may include one or more of enjoying the gaming, enjoying the streaming content, etc. What the customer does at the dealership 104 or during the test drive while the vehicle 102 is in parked mode helps in offering tailored packages involving Gaming, YouTube subscription to encourage customer to buy the vehicle 102. The dealership 104 may offer an upgraded in-vehicle infotainment (IVI) system based on customer's actions and upsell, or alternatively, a different vehicle 102 may be suggested.

In a fourth use case, a customer's repeated harsh slowing during test drives when there is a remote vehicle in front of the test drive vehicle 102 may be illustrative. The reminder for this behavior may include traffic in front of the vehicle 102 at the time that the customer presses the brakes or slows down. The routine may be that this customer tends toward a heavy foot. The reward may be to avoid an incident in traffic. Based on such connected data 112 the dealership 104 may, for example, offer a vehicle-to-everything (V2X) connectivity package to alert the customer and/or to initiate an avoidance feature to slow in a smoother manner.

In a fifth use case, a customer may be identified as having a desire for performance. The reminder for this behavior may be that the customer enjoys quick acceleration but stays within the speed limit. The routine may be that the customer may normally drive an electric vehicle but may be currently test driving an economy vehicle with less performance. The reward may be that the user may save money by choosing a vehicle 102 that is under budget although the performance is less. In such a situation, the dealership 104 may offer a discount on a base up-level vehicle or suggest a higher-end trim of the budget vehicle which has a performance package that may be better suited to the customer.

In a sixth use case, a customer spends time testing various vehicle 102 features on the HMI. The reminder for this behavior may be that the customer is tech-savvy. The routine for this behavior may be that the customer repeatedly tests technology features of the vehicle 102 through the HMI at the dealership 104 and/or during the test drive. The reward may be to minimize human interaction and to leverage technical advancements. In such a situation, the dealership 104 may offer a technology package as an option to the customer.

In a seventh use case, a customer tried to reverse park or parallel park to gain an understanding of the vehicle 102 driver assist features. The reminder for this behavior may be that the customer has a lack of skill with such maneuvers. The routine may be that the user tests the rear view camera, the warning system, the parking view, etc. The benefit may be an ease of parking. In such a situation, the dealership 104 may offer a parking assist package as an option to the customer.

An example portion of a customer's consolidated connected data 112 may be as shown in Table 1:

TABLE 1
Example Customer Connected Data

| User | VIN | Model | Use Case | Reminder | Routine | Reward | Offer |
|---|---|---|---|---|---|---|---|
| 1 | 1234 | Truck | Tech- | User | User tests | Minimize | Technology package |
| | | | Savvy | Enjoys | technology | user | |
| | | | | Tech | features | interaction | |
| 2 | 1234 | SUV | Customers | Customer | Turns on | Likes | Offer free streaming |
| | | | Entertainment | repeatedly | music in | music | account for one year |
| | | | Choices | plays | park and | | (or) a music channel |
| | | | | music via | during test | | collection package |
| | | | | Spotify | drive | | |
| . . . | . . . | . . . | . . . | . . . | . . . | . . . | . . . |

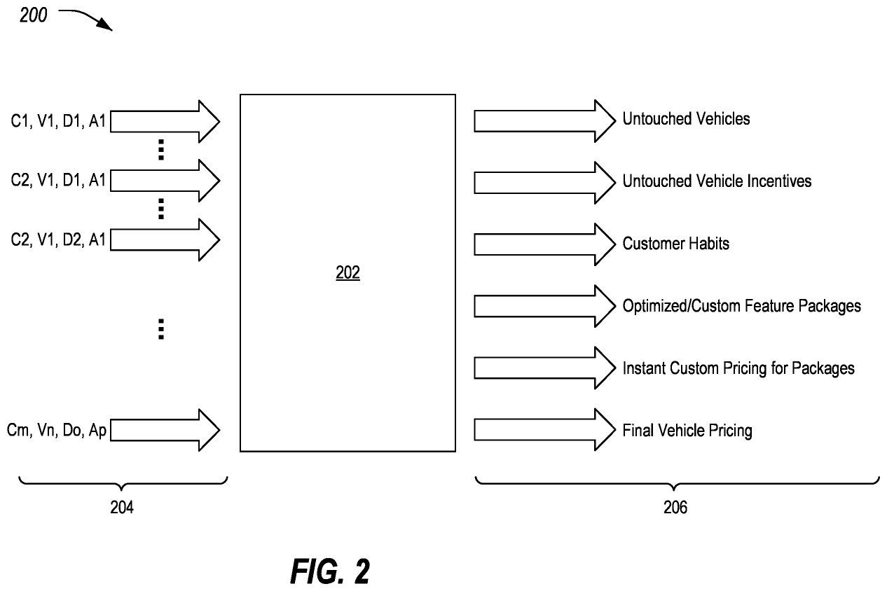

FIG. 2 illustrates an example 200 of operation of a machine learning component 202 to determine patterns in the connected data 112. As shown, the machine learning component 202 may receive connected data 112 as inputs 204 and may provide recommendations 206 as outputs.

The inputs 204 may include data and recommendations from various customers. vehicles 102, sellable combination of packages, test drives, and accessed vehicle 102 features. The inputs 204 may be preprocessed into a format for use by the machine learning component 202. In an example, the connected data 112 may be categories by customer (C), vehicle (V), dealership (D), and experience attribute (A). Each customer-C may test drive/check features of vehicle V at a dealership D for attributes A. The data from multiple vehicles test driven/feature tested at different dealerships for various attributes can be aggregated to offer customized or aggregated features, packages and/or incentives. The dealerships D1, D2 . . . Dp may be in different or same geographies. The experience attributes may include, for example, test drive parameters, indications of feature usage, etc.

This aggregated information may be fed to the machine learning component 202. The machine learning component 202 may be various types of computer learning system. In some examples, the machine learning component 202 may initially be a supervised learning system and later may be an automated learning component operating in an un-supervised manner. Once trained, the machine learning component 202 may be used to recommend incentives, new package offers, etc., as recommendations 206.

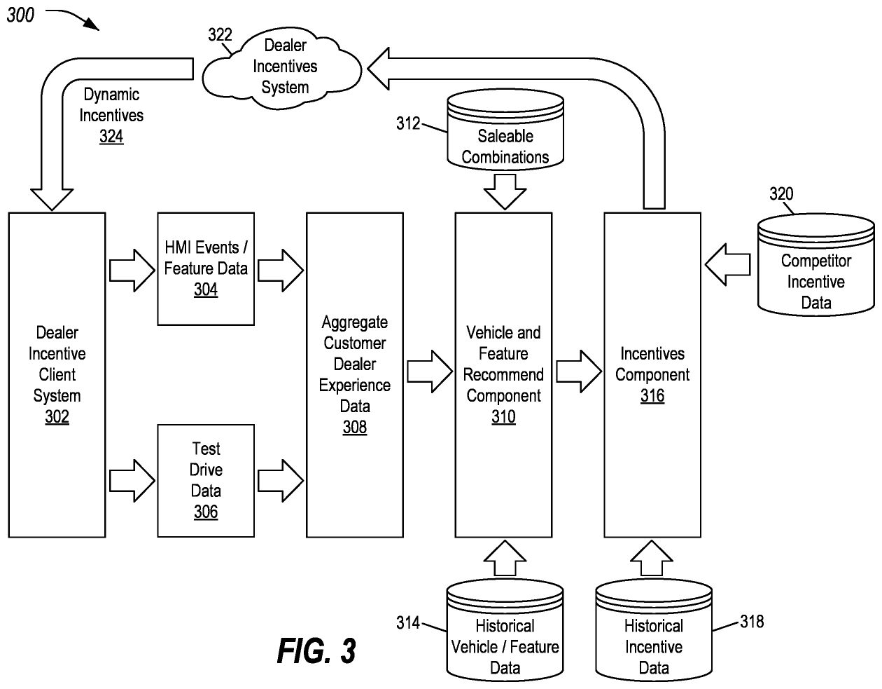

FIG. 3 illustrates an example data flow 300 for operation of the system 100 to analyze the connected data 112. In an example, the data flow 300 may be performed by the components discussed in FIGS. 1-2. A dealer incentive client system 302 may be performed by one or more computing devices at the dealerships 104. A feature recommend component 310, a database of saleable combinations 312, a database of historical vehicle feature data 314, an incentives component 316, historical incentive data 318, competitor incentive data 320, and a dealer incentives system 322 may be executed by the analysis server 110. Aspects of operation of the feature recommend component 310 and the incentives component 316 may be performed by the machine learning component 202.

A customer may go to the dealership 104 and may be met by a sales representative. The customer may provide information and what type of vehicle 102 that the customer is looking for. The customer information may be captured at the dealership 104. The customer may check the interior of various vehicles 102, check the exterior of various parked vehicles 102, access HMI features, and may ask questions. The customer may take the vehicle for a test drive to assess if it is a good fit for his choices. As there may be redundant data that comes out of the vehicle 102, the machine learning component 202 may utilize algorithms such as core sets to limit the connected data 112 that is used for recommending a vehicle 102 or incentive.

The dealerships 104 may utilize a dealer incentive client system 302 to collect the connected data 112 from the vehicles 102. In an example, the data collection application 118 may receive the connected data 112 from the vehicles 102. The connected data 112 may include data descriptive of HMI events/feature data 304 interactions of the customer with the vehicle 102 at the dealership 104. The connected data 112 may also include test drive data 306 descriptive of interactions of the customer with the vehicle 102 while driving. This data 304, 306 may be compiled into aggregate customer experience data 308 (such as noted with respect to FIG. 2), which may be provided to a vehicle and feature recommend component 310.

The events, telematics, features accessed, and other data is aggregated and sent to the cloud in real time. The recommender algorithm may tailor the recommendation 206 to the vehicle 102 the customer is test driving or suggest alternate vehicles 102. It also validates the sellable combination of features and vehicle 102 in making the recommendation 206. The feature recommend component 310 and the incentives component 316 may takes historical data from other customers as input to increase the accuracy and further train the machine learning component 202.

The feature recommend component 310 may also receive or otherwise access a database of saleable combinations 312. The saleable combinations 312 may include which combinations of features of the vehicles 102 may be buildable. This may be useful, as some features may require other features, and/or may require the absence of other features.

The feature recommend component 310 may also receive or otherwise access a database of historical vehicle feature data 314. This historical vehicle feature data 314 may include information about vehicles 102 that were previously sold as well as their feature configurations.

The feature recommend component 310 may utilize the aggregate customer experience data 308, saleable combinations 312 and historical vehicle feature data 314 to provide one or more feature recommendations. The output from the feature recommend component 310 is sent to incentives component 316 for incentives.

The incentives component 316 may utilize historical incentive data 318 descriptive of incentives that may have been offered previously for vehicles 102, and competitor incentive data 320 descriptive of incentives that may are or have been offered for competitor vehicles 102 not sold by the dealership 104 to provide a recommendation to a dealer incentives system 322 in the cloud. To suggest a best possible incentive or vehicle for a customer, a range of inputs like customer's income, interests, ability to pay may be used by decision tree algorithm(s) to recommend best suitable vehicle/feature packages.

The dealer incentives system 322 may utilize the recommendation to provide dynamic incentives 324 to the dealer incentive client system 302. These dynamic incentives 324 may be used by the dealership 104 to entice the customer to purchase one of the vehicles 102. The recommended incentive information may be sent to the dealership 104 via the dealer incentives system 322 in near real-time.

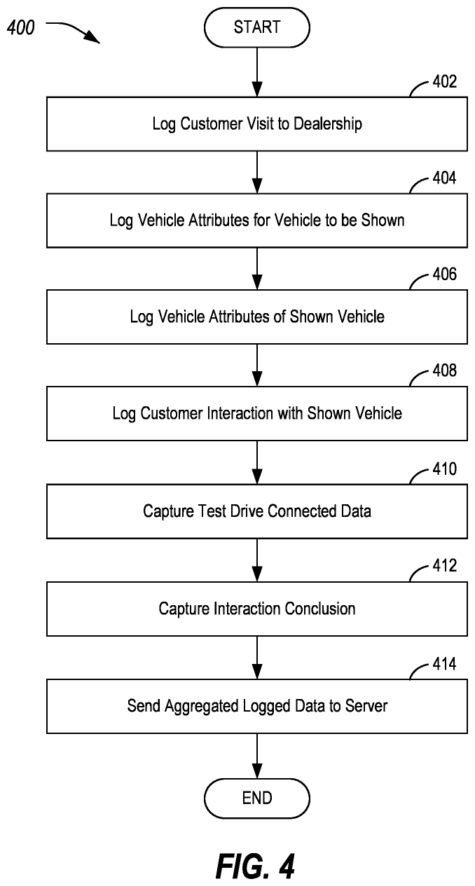

FIG. 4 illustrates an example process 400 for the collection of connected data 112 to be provided to the usage analysis service 116 for analysis. The process 400 depicts a flow of customer experience when a customer reaches the dealership 104. While the customer is interacting with the sales associate, the connected data 112 may be collected. During the interaction, a customer usually test drives a vehicle 102 prior to a purchase and this driving and HMI usage may be captured. Operations of the process 400 may be performed by components discussed in detail above.

At operation 402, the customer visit to the dealership 104 is logged. For instance, the customer may visit a dealership 104. The dealership 104 location (e.g., via global navigation satellite system (GNSS)) and/or the address of the dealership 104 may be logged. Information with respect to the specific customer may also be logged. If personally identifiable information (PII) of the customer is logged, the PII may be stored in a first database to assign the customer a unique identifier. The unique identifier may then be used to log the interaction details while preserving the customer's privacy.

At operation 404, the vehicle 102 attributes for the vehicles 102 of interest to the customer are logged. In an example, a sales associate may greet the customer and may discuss with the customer to understand the customer's needs. The information indicative of the customer's needs may be logged via the dealership 104.

At operation 406, attributers of the vehicle(s) 102 shown to the customer are logged. In an example, one or more of the VIN, location, ignition on/off status, and features of the vehicle 102 or vehicles 102 that are accessed may be logged. This logging may be performed responsive to opening a door, unlocking, or other HMI interaction with the vehicle 102. Or, the logging of vehicle 102 information may be triggered responsive to assigning a key or otherwise selecting to initiation the interaction to show the vehicle 102.

At operation 408, customer interaction with the vehicle(s) 102 are logged. In an example, for each feature access by the customer, the feature and the YIN, location, ignition on/off status of the vehicle 102 may added to the log. By differentiating between the features accessed by the sales staff and those accessed by the customer, the features of interest to the customer may be more readily identified.

At operation 410, test drive connected data 112 is logged. For example, if the customer drives the vehicle 102, connected data 112 may be logged, such as ignition status of the vehicles 102, which features of the vehicles 102 were accessed during which time periods, customer use of the HMI of the vehicle 102, ignition on/off times and locations, driving behavior of the vehicle 102, start points, paths, and/or end points for test drive routes that are traversed by the vehicles 102, distance traveled, time spent in the vehicles 102 by the customers.

At operation 412, a conclusion of the interaction of the customer to the vehicle 102 is logged. In an example, the end time of the interaction may be logged. In another example, whether the vehicle 102 was purchased may be logged. The conclusion time may be determined by the time that the vehicle 102 is exited, the vehicle 102 is locked, the customer exits the dealership 104, etc.

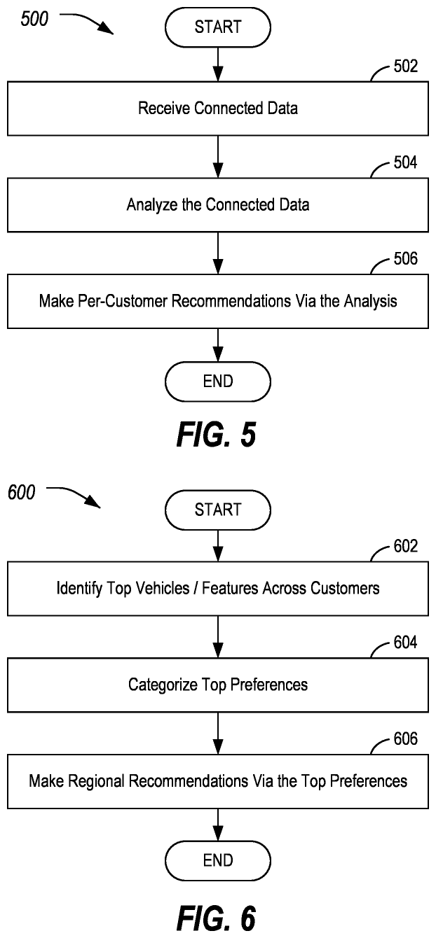

At operation 414, the aggregated log data is sent to the analysis server 110 to be used by the usage analysis service 116. In an example, the connected data 112 may be sent to the analysis server 110 via the communications network 108 using various protocols, such as hypertext transfer protocol secure (HTTPS), message queue telemetry transport (MQTT), Google remote procedure call (GRPC), etc. Further aspects of the analysis of the connected data 112 are discussed with respect to FIGS. 5-6.

FIG. 5 illustrates an example process 500 for the analysis of connected data 112 by the usage analysis service 116 of the analysis server 110 to provide per-customer recommendations 124. The process 500 may be performed by the usage analysis service 116 of the analysis server 110, in the context of the system 100. In an example, the connected data 112 may be received to the analysis server 110 due to performance of the process 400 discussed in detail above.

At operation 502, the analysis server 110 receives the connected data 112. In an example, the connected data 112 may be received as sent at operation 414 of the process 400. It should be noted that while the processes 400 and 500 and illustrated as linear, the connected data 112 may be captured while the customer is at the dealership 104, and the operations of the process 500 may be performed dynamically based on customer actions performed to the vehicle 102, periodically, responsive to receipt of connected data 112 from the dealerships 104, etc. This may allow the system 100 to provide recommendations 124 to the dealership 104 while the customer is still at the dealership 104 shopping for vehicles 102.

At operation 504, the analysis server 110 identifies patterns in the connected data 112. In an example, the analysis server 110 may utilize machine learning algorithms to determine recommendations 124 consistent with the connected data 112 that may enable the dealership 104 to close a deal with the customer. In an example, the analysis server 110 may suggest alternative vehicles 102 for the customer based on connected data 112. For instance, the driving behavior of the customer interacting with the accelerator pedal may indicate that the customer is looking for a vehicle 102 with faster acceleration. Or, the mix of highway driving vs. surface roads may indicate that the customer may desire a vehicle 102 with a hands-free highway driving functionality.

At operation 506, the analysis server 110 makes recommendations 124 based on the connected data 112. In an example, the recommendations 124 may be provided to the dealership 104 while the customer is still at the dealership 104. This may allow the dealership 104 to be dynamically advised on alternative vehicles 102 that may allow the dealership 104 to close the deal. After operation 506, the process 500 ends.

FIG. 6 illustrates an example process 600 for using abstracted data from a plurality of instances of connected data 112 to offer recommendations 124 across multiple customers. As with the process 300, the process 600 may be performed by the usage analysis service 116 of the analysis server 110, in the context of the system 100.

At operation 602, the analysis server 110 identifies top vehicles 102 and/or top features across instances of connected data 112. In an example, the analysis server 110 may utilize the connected data 112 for a plurality of customers at a given dealership 104 or dealerships 104 to identify, for the dealership(s) 104, the features that are most accessed by the customers. In another example, the analysis server 110 may utilize the connected data 112 for a plurality of customers to identify the vehicles 102 that are most accessed by the customers.

At operation 604, the analysis server 110 categorizes the top preferences. In an example, the analysis server 110 may determine using the top features or vehicles 102, which features or vehicles 102 are most desired across customers. In another example, the analysis server 110 may determine using the top features or vehicles 102, which features or vehicles 102 are most desired in combination with one another across the customers (e.g., using clustering or other data mining techniques). In yet another example, the analysis server 110 may determine which features are most desirable alone or in combination per geographical area such as city, state, region (e.g., New England, mid-Atlantic, South, Midwest, Southwest, West), etc.

At operation 606, the analysis server 110 makes regional recommendations 124 across multiple customer's connected data 112. In an example, the analysis servers 110 may provide recommendations 124 to promote incentives on vehicles 102 that are not top preferences to increase the turn rate of the less desired vehicles 102. In another example, the analysis servers 110 may provide recommendations 124 that include to advertise or provide incentives, in the geographical areas, those vehicles 102 that are top preferences in the corresponding geographical area. After operation 606, the process 600 ends.

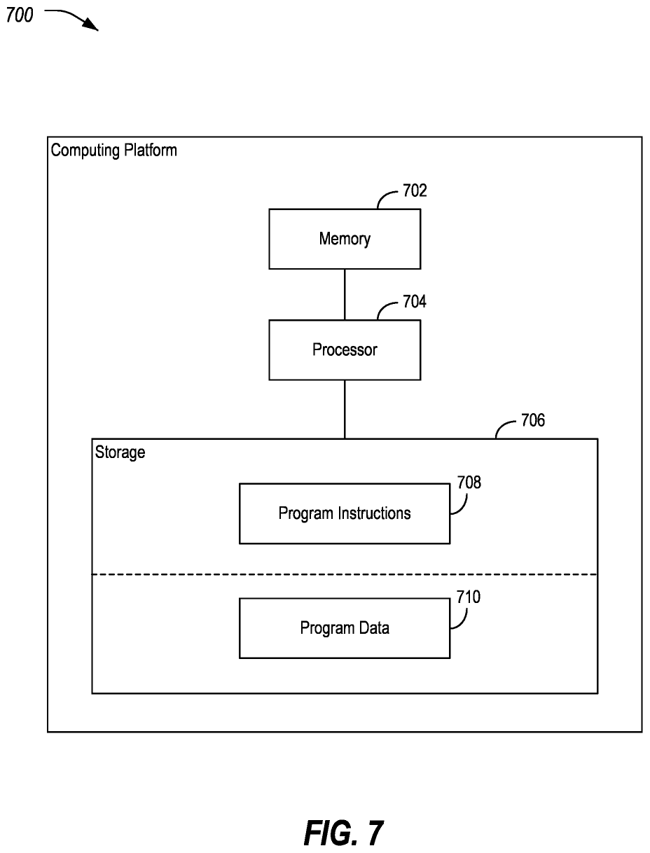

FIG. 7 illustrates an example computing device 702 for performing vehicle 102 analytics using connected data 112 captured from potential vehicle 102 customers. Referring to FIG. 7, and with reference to FIGS. 1-6, the vehicles 102, dealerships 104, mobile devices 106, communications network 108, and analysis servers 110 may include examples of such computing devices 702. Computing devices 702 generally include computer-executable instructions, such as those of the usage analysis service 116, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as connected data 112, and recommendations 124, may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A system for performing vehicle analytics using connected data captured from potential vehicle customers, comprising:
a server including a hardware processor configured to execute a usage analysis service to:
receive connected data indicative of usage by a customer of one or more vehicles in real-time,
analyze the connected data to determine an individualized per-customer recommendation based on the usage, and
send the per-customer recommendation to a dealership in real-time to provide the dealership with individualized incentives or recommendations for enticing the customer to purchase one of the one or more vehicles.

2. The system of claim 1, wherein the connected data indicates which features of the vehicles were accessed by the customer.

3. The system of claim 1, wherein the connected data indicates a route traversed by the customer operating the one or more vehicles.

4. The system of claim 1, wherein the connected data indicates vehicle ignition on and off times for use in determining when the customer was accessing features of the one or more vehicles.

5. The system of claim 1, wherein the per-customer recommendation indicates a proposed vehicle available at the dealership.

6. The system of claim 1, wherein the server is further configured to:
receive second connected data indicative of second usage by a second customer of the one or more vehicles,
identify top features across the connected data and the second connected data, and
send a cross-customer recommendation to the dealership to advise the dealership with respect to a plurality of customers.

7. The system of claim 6, wherein the cross-customer recommendation includes an incentive on vehicles that lack the top features to increase turn rate of the vehicles lacking the top features.

8. The system of claim 6, where the cross-customer recommendation includes incentives for vehicles that include the top features.

9. A method for performing vehicle analytics using connected data captured from potential vehicle customers, comprising:
receiving connected data indicative of usage by a customer of one or more vehicles in real-time,
analyzing the connected data to determine a per-customer recommendation based on the usage, and
sending the per-customer recommendation to a dealership in real-time to provide the dealership with individualized incentives or recommendations for enticing the customer to purchase one of the one or more vehicles.

10. The method of claim 9, wherein the connected data indicates which features of the vehicles were accessed by the customer.

11. The method of claim 9, wherein the connected data indicates a route traversed by the customer operating the one or more vehicles.

12. The method of claim 9, wherein the connected data indicates vehicle ignition on and off times for use in determining when the customer was accessing features of the one or more vehicles.

13. The method of claim 9, wherein the per-customer recommendation indicates a proposed vehicle available at the dealership.

14. The method of claim 9, further comprising:
receive second connected data indicative of second usage by a second customer of the one or more vehicles,
identify top features across the connected data and the second connected data, and
send a cross-customer recommendation to the dealership to advise the dealership with respect to a plurality of customers.

15. The method of claim 14, wherein the cross-customer recommendation includes an incentive on vehicles that lack the top features to increase turn rate of the vehicles lacking the top features.

16. The method of claim 14, where the cross-customer recommendation includes incentives for vehicles that include the top features.

17. A non-transitory computer-readable medium comprising instructions for performing vehicle analytics using connected data captured from potential vehicle customers, that, when executed by a server, cause the server to perform operations including to:
receive connected data indicative of usage by a customer of one or more vehicles in real-time;
analyze the connected data to determine a per-customer recommendation based on the usage; and
send the per-customer recommendation to a dealership in real-time to provide the dealership with individualized incentives or recommendations for enticing the customer to purchase one of the one or more vehicles.

18. The medium of claim 17, wherein the connected data indicates one or more of:
which features of the vehicles were accessed by the customer;
a route traversed by the customer operating the one or more vehicles; or
vehicle ignition on and off times for use in determining when the customer was accessing features of the one or more vehicles.

19. The medium of claim 17, wherein the per-customer recommendation indicates a proposed vehicle available at the dealership.

20. The medium of claim 17, wherein the server is further configured to:
receive second connected data indicative of second usage by a second customer of the one or more vehicles,
identify top features across the connected data and the second connected data, and
send a cross-customer recommendation to the dealership to advise the dealership with respect to a plurality of customers.
